(19) United States
(12) Patent Application Publication
(10) Pub. No.: US 2024/0260768 A1
(43) Pub. Date: Aug. 8, 2024

(54) A NEW TYPE OF ELECTRIC HEATING BLANKET

(71) Applicants: Guangshan BIAN, Guiyang, Guizhou (CN); Weiwei ZHOU, Guiyang, Guizhou (CN); Xite BIAN, Guiyang, Guizhou (CN); Shufen BIAN, Guiyang, Guizhou (CN)

(72) Inventors: Guangshan BIAN, Guiyang, Guizhou (CN); Weiwei ZHOU, Guiyang, Guizhou (CN); Xite BIAN, Guiyang, Guizhou (CN); Shufen BIAN, Guiyang, Guizhou (CN)

(21) Appl. No.: 18/565,757

(22) PCT Filed: Aug. 16, 2022
(86) PCT No.: PCT/CN2022/112774

§ 371 Date: Nov. 30, 2023

(30) Foreign Application Priority Data
Sep. 12, 2021 (CN) 202111065363.X

(51) Int. Cl. A47G 9/02; H05B 1/02; H05B 3/00; H05B 3/14; H05B 3/34

(52) U.S. Cl. CPC A47G 9/0215; H05B 3/0019; H05B 3/146; H05B 3/347; A47G 2200/166; H05B 1/0272

(57) ABSTRACT

This invention has fundamentally rewritten the technological history of electric heating blanket. The main body of this new type of electric heating blanket provided by this invention does not contain wires with metal components, it completely eradicates the phenomenon of contact sparking, burning, and conflagration disasters caused by the fracture of wires with metal components due to stretching and folding during usage. This new type of electric heating blanket does not contain wires with metal components, which can conserve metal resources. This new type of electric heating blanket operates at a voltage of 24 volts, which is consistent with the international standard for safe voltage. It will never cause injury to humanity due to electric shock during the use of this new type of electric heating blanket. The main body of this electric heating blanket can be washed by hand or in a washing machine since it does not contain wires with metal components. And it has the Ultra-thin characteristics (thickness is regular cloth thickness), softness, breathability, and excellent tactile sensation. It feels just like a regular piece of cloth when touching it. This new type of electric heating blanket has the ability to bake bedding, which can quickly remove moisture from bedding. (The temperature of this new type of electric heating blanket can be adjusted from 30° C. to a maximum temperature of 55° C.).

### 1. FIELD OF THE INVENTION

The present invention relates to an electric heating blanket, in particular to a new type of electric heating blanket wherein the main body of the electric heating blanket does not contain wires with metal components.

### 2. BACKGROUND OF INVENTION

In the prior art, U.S. patent Ser. No. 11/091,856 discloses an electric heating cloth having gaps and a connection structure, which comprises plural conductive yarns arranged in a first direction, plural textile yarns and plural metal conductive wires arranged in a second direction.

### The Above-Mentioned Prior Art has the Following Deficiencies:

The above-mentioned prior art comprises plural textile yarns and plural metal conductive wires arranged in a second direction for interweaving with the conductive yarns in a first direction, and the metal conductive wires in the electric heating cloth above, which are used for conducting current, are frequently stretched and folded. Due to being frequently stretched and folded, the metal conductive wires are prone to fracture and cause contact sparking, burning, and conflagration disasters during usage.

In the prior art, Chinese Patent No. CN201911065914 discloses a machine-woven graphene filament electric heating cloth, which claims that the characteristic of this patent is that the conductive fiber filaments used to power the electric heating cloth can be: carbon fiber filaments, carbon composite fiber filaments, copper ammonia fiber filaments, polyaniline fiber filaments, polypyrrole fiber filaments, metal-electroplated polyimide fiber filaments, metal-electroplated aramid fiber filaments and metal-electroplated glass fiber filaments, the electroplated metal can be gold, silver, copper, or nickel.

The above-mentioned prior art has the following deficiencies:
\textcircled{1} It is quite dangerous and lacks safety to use carbon fiber filaments (with a carbon content of 95%) and carbon composite fiber filaments (with a carbon content of 80% to 90%) as the conductive fiber filaments of the electric heating cloth to conduct higher currents and continuously supplying power to the electric heating cloth. This is because these two materials have a high carbon content, which makes them very brittle and extremely prone to fracture. The electric heating cloth is frequently folded during use, and these two materials do not deform when bent but instead directly fracture, which cannot be repaired once damaged.
\textcircled{2} Due to the lower electrical conductivity of copper ammonia fiber filaments, polyaniline fiber filaments, and polypyrrole fiber filaments, they are not suitable to be used as conductive fiber filaments to continuously provide higher currents for the electric heating cloth.
\textcircled{3} When using the metal-electroplated polyimide fiber filaments, metal-electroplated aramid fiber filaments, and metal-electroplated glass fiber filaments as conductive fiber filaments, these metal-electroplated fiber filaments are prone to fracture and causes contact sparking, burning and conflagration disasters due to being frequently stretched and folded during usage.

### 3. SUMMARY OF THE INVENTION

In order to address the deficiencies of the above-mentioned prior art, the present invention provides a new type of electric heating blanket that the main body of the electric heating blanket does not contain wires with metal components. This electric heating blanket is woven by ordinary aramid yarns, the non-metallic graphene aramid heating yarns, and the non-metallic aramid/MXene electric conductive yarns by using looms. This new type of electric heating blanket is capable of conducting electricity and generating heat. Due to the main body of the electric heating blanket does not contain wires with metal components, it completely eliminates the phenomenon of causing contact sparking, burning and conflagration disaster caused by stretching, folding, and fracturing during the use of the electric heating blanket.

This new type of electric heating blanket comprises: a main body capable of conducting electricity and generating heat and woven by yarns, warp yarns, weft yarns by using looms, wires with mains electricity, a voltage converter, wires with a 24-volt voltage, a temperature controller, wires, electric conductive yarns for a temperature sensor, fastener and a temperature sensor; wherein the electric conductive yarns, forming the electric conductor in the warp direction, woven into the main body of the electric heating blanket by using looms, are non-metallic yarns. The heating yarns, forming the heating conductor interwoven in the weft direction, woven into the main body of the electric heating blanket by using looms, are non-metallic yarns.

### COMPARED WITH THE PRIOR ARTS, THE INVENTION HAS THE FOLLOWING ADVANTAGES

(1) This invention has fundamentally rewritten the technological history of electric heating blanket.

(2) The main body of this new type of electric heating blanket provided by this invention does not contain wires with metal components, it completely eradicates the phenomenon of contact sparking, burning, and conflagration disasters caused by the fracture of wires with metal components due to stretching and folding during usage.

(3) This new type of electric heating blanket does not contain wires with metal components, which can conserve metal resources.

(4) This new type of electric heating blanket operates at a voltage of 24 volts, which is consistent with the international standard for safe voltage. It will never cause injury to humanity due to electric shock during the use of this new type of electric heating blanket.

(5) The main body of this electric heating blanket can be washed by hand or in a washing machine since it does not contain wires with metal components. And it has the Ultra-thin characteristics (thickness is regular cloth thickness), softness, breathability, and excellent tactile sensation. It feels just like a regular piece of cloth when touching it.

(6) This new type of electric heating blanket has the ability to bake bedding, which can quickly remove moisture from bedding. (The temperature of this new type of electric heating blanket can be adjusted from 30° C. to a maximum temperature of 55° C.).

### 4. BRIEF DESCRIPTION OF ACCOMPANY DRAWINGS

FIG. 1 is a schematic view showing the connection of circuit diagram of a new type of electric heating blanket.

FIG. 2 is a schematic view showing the structure of front view and side view of a new type of electric heating blanket.

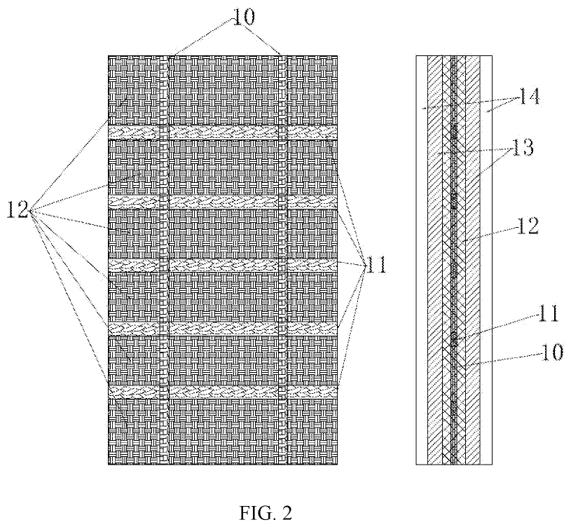

FIG. 3 is a schematic view showing a temperature sensor and the electric conductive yarns for the temperature sensor.

FIG. 4 is a three-dimensional schematic view of a new type of electric heating blanket.

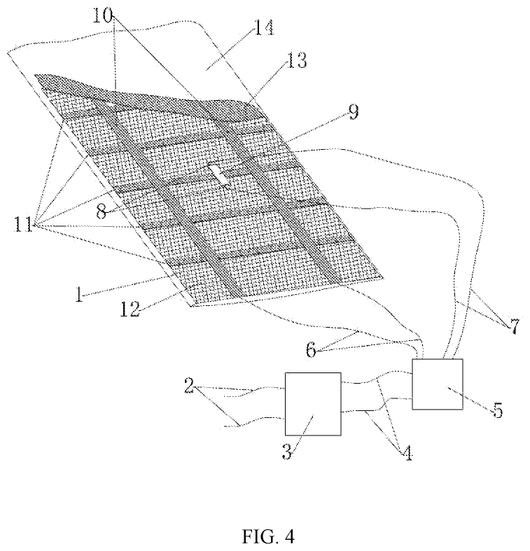

### 5. DETAIL DESCRIPTION OF THE INVENTION

To make the technical solutions provided by the invention more comprehensible, a further description of the invention is given below in combination with the accompanying drawings and embodiments.

The weft heating yarns (11) of graphene aramid and the warp electric conductive yarns (10) of aramid/MXene are woven by using looms to form the main body of the conductive heating circuit, which can conduct electricity and generate heat at a certain voltage; the weft heating yarns (11) of graphene aramid and the warp electric conductive yarns (10) of aramid/MXene are between the regular aramid yarns (12), and the three types of yarn form a complete electric heating blanket.

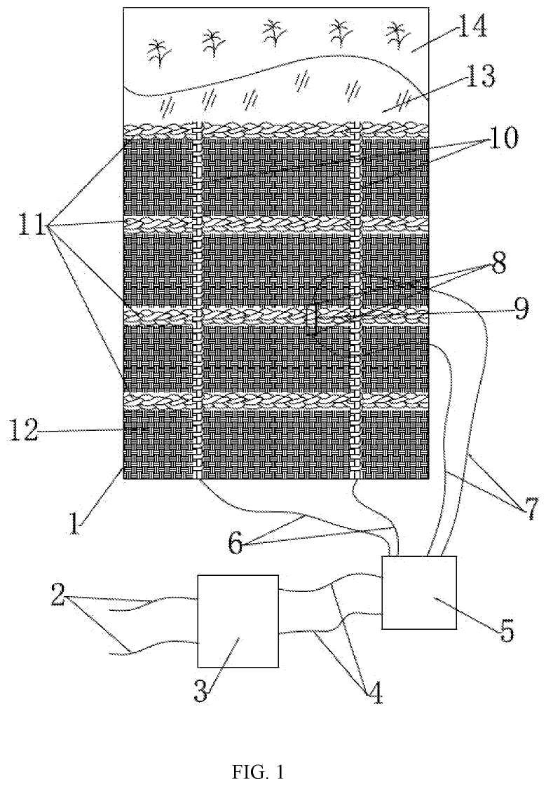

The weft heating yarns (11) of graphene aramid are embedded and woven at a certain distance in the weft direction of the electric heating blanket, as shown in FIG. 1, labeled as 11.

The warp electric conductive yarns (10) of aramid/MXene are embedded and woven on both sides of the electric heating blanket in the warp direction, as shown in FIG. 1, labeled as 10.

As shown in FIG. 1. A new type of electric heating blanket comprises: a main body (1) of the electric heating blanket, wire (2) with mains electricity is connected to the input of a voltage converter (3) which enables the voltage ranging from 110 volts to 220 volts to be converted to 24 volts, wire (4) with a 24-volt voltage is connected to the output of the voltage converter (3) and the temperature controller (5), wire (6) with a 24-volt voltage is connected as positive and negative poles to the output of the temperature controller (5) and the positive and negative poles of the warp electric conductive yarns (10) of aramid/MXene, the output of the temperature controller (5) is connected to electric conductive yarns (7) of the temperature sensor, electric conductive yarns (7) of the temperature sensor are respectively connected to the fasteners (8), the fasteners (8) are connected to temperature sensor (9).

### The Warp Electric Conductor of Aramid/MXene:

The warp electric conductor of aramid/MXene is composed of plural electric conductive yarns of aramid/MXene and woven in the warp direction of the electric heating blanket by using looms, it has the function of conducting electricity, as shown in FIG. 1, labeled as 10.

### The Weft Heating Conductor of Graphene Aramid:

The weft heating conductor of graphene aramid is composed of plural heating yarns of graphene aramid and woven in the weft direction of the electric heating blanket by using looms, it has the function of generating heat, as shown in FIG. 1, labeled as 11.

### The Electric Conductive Yarns for a Temperature Sensor:

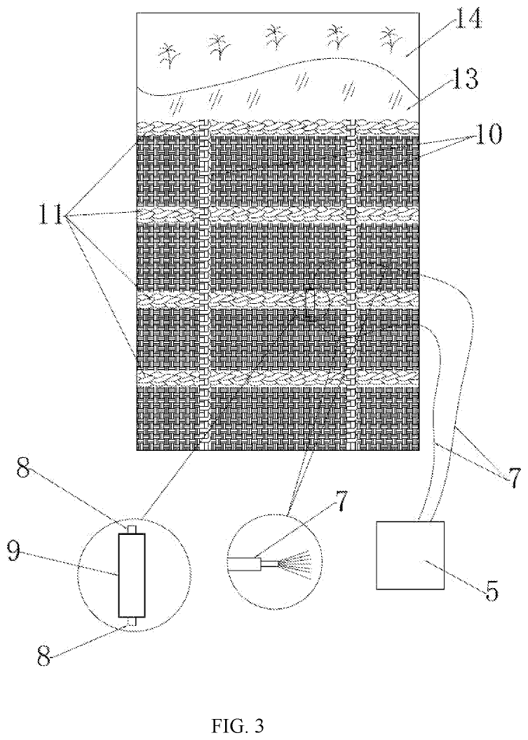

The electric conductive yarns for the temperature sensor are composed of plural electric conductive yarns of aramid/MXene, and they are wrapped with insulation layer, they are mainly used for conducting the temperature signal of the temperature sensor, a portion of the temperature sensor's electric conductive yarns are manually secured and sewn onto the main body of the electric heating blanket, as shown in FIG. 3, labeled as Circle 7.

### The Insulation and Thermal Conducting Layer of the Electric Heating Blanket:

The insulation and thermal conducting layer is applied to the front and back of the electric heating blanket using a spray printing process, it provides insulation and thermal conduction for the electric heating blanket. This layer is characterized by its breathability, softness, good tactile sensation, resistance to folding, and ability to withstand water washing, as shown in FIG. 3, labeled as 13.

### The Outer Cover of the Electric Heating Blanket:

The outer cover of the electric heating blanket is made of pure cotton bed sheet, as shown in FIG. 3, labeled as 14.

### The Fastener of the Temperature Sensor:

The fastener of the temperature sensor is used to connect the temperature sensor to the temperature sensor's electric conductive yarns, as shown in FIG. 3, labeled as 8.

### The Voltage Converter:

The voltage converter is mainly used to enable the voltage ranging from 110 volts to 220 volts to be converted to 24 volts.

### The Temperature Controller:

The temperature controller is mainly used to enable the temperature of the electric heating blanket to be adjusted between 30° ° C. and 55° C.

### The Warp Electric Conductive Yarns of Aramid/MXene for the Electric Heating Blanket:

MXene is a two-dimensional material. This new material was researched by Drexel University in the United States and it has hydroxyl groups on its surface. MXene material possesses the metallic electrical conductivity of transition metal carbides. This material has strong electrical conductivity and can completely replace copper and aluminum materials in electrical wires.

Aramid fiber is a flexible macromolecular material that has a soft touch feeling and good spinnability, it possesses excellent flame resistance and heat resistance, and can be continuously used at temperatures up to 205° C. without causing harm to human health and the environment. Aramid fiber is a permanently flame-retardant fiber, determined by its own chemical structure. The flame resistance of aramid fiber will not diminish with long-term use and frequent washing. Aramid fiber has strong tensile and cut resistance, and it is not easy to be cut by ordinary scissors.

Aramid nanofibers provide excellent tensile strength due to their high homology, high length-to-diameter ratio, and entangled hydrogen bonds between fibers; MXene has hydroxyl groups to form hydrogen bonds with aramid nanofibers at the interface, and the shrinkage effect of the fibers themselves during the drying reduces the interface difference between the two substrates. Based on the above process, it can be concluded that aramid/Mxene composite fiber yarns are highly desirable as composite electric conductive yarns.

Utilizing the characteristics of MXene material and aramid fibers, they can be combined to produce aramid/MXene composite yarns which are non-metallic and has strong electric conductivity. The aramid/MXene composite yarns can be used as the weaving material of the warp direction in the manufacture of electric heating blanket. This aramid/MXene composite yarns replace the current use of metallic wires or the metal-electroplated conductive fiber filaments as the weaving material in current electric blanket manufacturing technology, completely eliminates the phenomenon of contact sparking, burning and conflagration disaster caused by fracture of metallic wires or the metal-electroplated conductive fiber filaments. In addition, the aramid/MXene composite yarns also replace carbon fiber filaments and carbon composite fiber filaments, which are currently used as conductive materials in the electric blanket manufacturing technology, to completely eliminate the deficiencies of that these two materials have high carbon content, high brittleness and susceptibility to fracture which results in the inability to deform and the inability to be repaired after damage. And the aramid/MXene composite yarns also replace copper-ammonia fiber filaments, polyaniline fiber filaments and polypyrrole fiber filaments, which are currently used as conductive materials in the electric blanket manufacturing technology, to completely eliminate the deficiencies of that these three materials cannot continuously provide a large current due to their lower electrical conductivity.

The preparation method of electric conductive yarns of aramid/MXene comprises the following steps:
1. Preparation of aramid nanofiber solution: Mix aramid short-cut nanofibers with dimethyl sulfoxide (DMSO) to obtain aramid nanofiber solution.
2. Preparation of the MXene/DMSO spinning solution.
3. Preparation of aramid nanofiber/MXene composite spinning solution: Mix the MXene/DMSO solution with the aramid nanofiber solution.
4. Preparation of aramid/MXene composite electric conductive yarns: Extrude the aramid nanofiber/MXene composite spinning solution through the spinneret orifice of spinneret, then being cooled, stretched, and wound around by passing through a water tank, and finally obtain aramid/MXene electric conductive yarns.

The aforementioned aramid/MXene electric conductive yarns possess outstanding electrical conductivity, temperature resistance, resistance to stretching and folding, it can be washed, woven, and has permanent flame retardancy, which is satisfied for use as the warp electric conductive yarns in the electric heating blankets.

### The Weft Heating Yarns of Graphene Aramid Fiber for the Electric Heating Blanket:

Graphene is a new type of material. It has the advantages such as lightweight, ultrathin, flexibility, spinnability, excellent electrical conductivity and heating conductivity, low resistivity, etc. However, graphene material cannot be guaranteed for repeated stretching and folding when used in the electric heating blanket manufacturing due to its low material strength.

In order to solve the aforementioned issues and ensure that graphene material can be used in electric heating blanket manufacturing, aramid fibers can be combined with graphene to meet the usage standards in electric heating blanket manufacturing (aramid fibers have been described previously).

### The Preparation Method of Heating Yarns of Graphene Aramid Comprises the Following Steps:

Dissolve schistose graphene with a mass fraction of 3-5% in N-Methyl-2-pyrrolidone solution, then add phytic acid and stir, then add aramid pulp and continue stirring to obtain the graphene-aramid slurry; next, obtain the heating yarns of graphene aramid through the wet spinning process of the graphene-aramid slurry, which are used for manufacturing the weft heating yarns in electric heating blanket.

The preceding text describes the present invention and its embodiments, but this description is not restrictive and does not impose any limitations. The illustrated embodiment is one of the preferred embodiments of the present invention, but the actual structure is not limited to this embodiment.

1. A new type of electric heating blanket, has a main body (1) capable of conducting electricity and generating heat and woven by yarns, warp yarns, weft yarns by using looms, wires (2) with mains electricity, a voltage converter (3), wires (4) with a voltage of 24 volts, a temperature controller (5), wires (6), electric conductive yarns (7) for a temperature sensor, fastener (8) and a temperature sensor (9), the non-metallic heating yarns (11) forming the heating conductor, insulation layer(13) of the electric heating blanket, the characteristic is that the electric conductive yarns (10) are non-metallic nature aramid/MXene composite yarns.
